(19) United States
(12) Patent Application Publication
(10) Pub. No.: US 2012/0027374 A1
(43) Pub. Date: Feb. 2, 2012

(54) METHODS AND SYSTEMS FOR CONTROL OF MULTIPLE MULTIMEDIA TUNERS

(76) Inventor: Harry Ira Lipkind, Mount Dora, FL (US)

(21) Appl. No.: 13/013,577

(22) Filed: Jan. 25, 2011

Related U.S. Application Data
(60) Provisional application No. 61/298,210, filed on Jan. 25, 2010.

(51) Int. Cl. H04N 5/775; H04N 9/80

(52) U.S. Cl. 386/230; 386/239; 386/E09.011; 386/E05.07

(57) ABSTRACT

A system and method for signal virtualization, such as television signals. Signal source components such as television tuners supply television signals to be converted to computer-readable signals. Recording modules receive the converted computer-readable signals for implementation as data signals. A host server receives the data signals for serving to one or more frontend session components. A storage component of the host server (e.g., a hard disk) optionally stores one or more of the data signals in respective data files corresponding to respective video programs. A playback module receives the data signals from the host server and implements the data signals as television signals to be displayed on a television monitor component.

### CROSS-REFERENCE TO RELATED APPLICATIONS

This application claims the benefit of U.S. Provisional Patent Application Ser. No. 61/298,210 entitled “METHODS AND SYSTEMS FOR CONTROL OF MULTIPLE MULTIMEDIA TUNERS” and filed Jan. 25, 2010. The entirety of the above-noted application is incorporated by reference herein.

### BACKGROUND

The implementations disclosed herein generally relate to TV recording systems, and more particularly, a system for managing and distributing multiple tuners. Different schemes are used to address the limitations of tuners. Sometimes, to overcome the problems, it may be desirable to “over-design” the product. As a result, there is a need in the art for other methods and systems for controlling DVR output.

There are a number of basic limitations with home digital video recorders (DVR) such as TiVo. These systems are generally limited to two tuners which limit the number of channels that can be received by any one unit at a time. For example, a single HD television typically has only one HD/DVR attached to it. In addition, it is possible to have a second DVR with no HD television attached to it. As result, a user is unable to record three programs or more at a time. Furthermore the DVR can only be used for a few hours per day, wasting input and taking space.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The present disclosure relates to a system and method for using multiple tuners to provide a scalable solution to current home entertainment centers. Certain illustrative embodiments of the present disclosure may allow control of other resources such as telephone systems, HVAC, alarms, etc.

In one illustrative implementation, the present disclosure can employ tuner isolation in which copies of individual operating systems are used to enable protection of operations for delivery of a consistent recording of a program, without crashes due to multiple tuners corrupting the available memory.

Other advantages and novel features may become apparent from the following detailed description when considered in conjunction with the drawings.

### BRIEF DESCRIPTION OF THE DRAWINGS

The present disclosure can be more hilly appreciated with reference to the following detailed description of the disclosure when considered in connection with the following figures, in which reference numerals identify like elements. The following drawings are for the purpose of illustration only and are not intended to be limiting of the disclosure, the scope of which is set forth in the claims that follow.

FIG. 1 is a flowchart providing an overview of a basic operation of the system and details the functions of various systems and subsystems as they power on.

FIG. 2A, 2AA, 2B, and 2C are block diagrams of an exemplary computing environment for practicing the subject matter.

### DETAILED DESCRIPTION

Detailed descriptions of illustrative embodiments are provided herein. It is understood that the present embodiments may be embodied in various forms. As a result, specific details disclosed herein are not to be interpreted as limiting, but rather as a representative basis for teaching one skilled in the art to employ the present implementations in any appropriately detailed system, structure or manner.

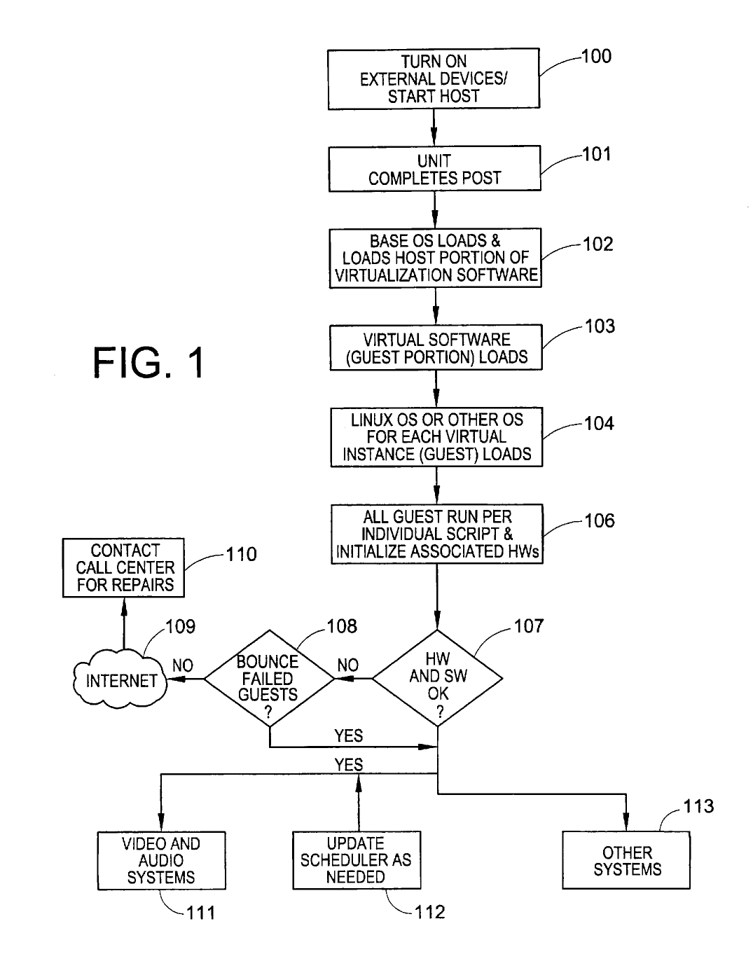

With respect to FIG. 1, an illustrative method is described below. While various actions are described herein either separately or in combination with other actions, this description is for illustrative purposes only. The actions may be combined, separated, or performed in any order desired by those skilled in the art. Additionally, other actions may be added or removed as desired, depending on a particular application.

One implementation begins with the initialization (100) (FIG. 1) of a host system component. It is desirable for this action to also result in powering on of any external items, followed by powering-on the central host system component. At (101), the BIOS of the host system runs a self-diagnostic and other tests, including tests of the internal systems and selected external connected systems. One advantage of performing tests of this type is that the present system may confirm that the various systems are functioning correctly.

Along these lines, one action that may be performed after post allows the host system hardware to load a host operating system (102) (FIG. 1) and a host portion of the virtualization software package. Then, the system startup script may load all, or a portion of, the initialized guest images (103). Each of the startup scripts can be loaded (104) in the execution of each guest image. Substantially all guest images may be initialized (106) so that they can run their startup scripts and attempt to initialize associated hardware. At the conclusion of the guest startup script, a logic check (107) may be executed to determine if the startup was complete and correct. If the startup was complete, control can be passed to the “valid” option. If the startup was not complete/correct, indicated as “NO,” control may be passed to restart the guest.

In the event that a guest fails (108) (FIG. 1), the system may be shutdown and restarted. If the restarted guest does not start correctly on a second attempt (indicated as “NO”), a message may be sent to the system manager reporting the problem. If the manager is knowledgeable, he/she can take appropriate steps to correct a problem or refer it to an external service firm (109). If the owner has a contract in place for automated support, the system can contact the call center automatically (110). Staff at the call center may then take appropriate action.

Skilled artisans will recognize that the call center may take a number of actions, some of which may be corrective. For instance, the call center may ship repair parts for installation by the owner, schedule and dispatch a technician, or schedule a technician, and if the facility is equipped set the alarm system, allow access. In one aspect, the system may be left running and therefore enabled to update its program listings on a preset schedule. If the system has been powered off for more than 24 hours, as can be determined by comparing the system clock with date and time on the program schedule file, the system does a special update of the program scheduler (112) (FIG. 1). Those systems that are configured to support audio and/or video operations “advertise” their availability or run previously created jobs (111).

In the logic check (107) (FIG. 1), the “YES” indicates a successful startup of a guest OS, the application running therein (e.g., MythTV or Windows Media Center (WMC)), and dedicated hardware, as presently described herein below. Those guests intended to support organization tasks (family, business, or government) may either be in standby or running assigned tasks (113).

In an exemplary implementation, the overall host of the system can be a host operating system (OS) installed directly on a hardware component. The implementation can include a Linux server installation, for example, SuSE or RedHat, though it is to be appreciated that any Linux server OS could be contemplated. After installing the OS, the next item installed is a virtualization system host component. Without limitation, and only by way of illustration, it is contemplated that Vmware, Xen, or KVM could be employed, or a suitable similar application. The virtualization host component then generates a guest instance into which is installed a copy of an OS, which could be, for example, Linux or Windows. These guest operating systems can be (but are not limited to) “desktop” versions. A RedHat desktop OS can be installed on a SuSE host OS. Within these “guest” OS installations, a media player application such as MythTV can be installed if the guest OS is Linux. In an example where the guest OS is Windows, a media player application such as WMC component or another similar application can be installed.

The guest OS and media player application initializes a specific tuner to which it has been assigned, where the tuner is selected from n identical tuners. In one aspect, there could be one type of tuner installed, capable of receiving and sending off for recording any channel the user has selected (or licensed from a local cable company). Alternatively, any number of types of tuners could be installed. In another aspect, an implementation can be envisioned where the user, for example, could record up to a dozen channels and can select from six good-quality “off the air” (OTA) signals available in their area. In this implementation, the user could have six OTA tuners operating respective guest OS instances with respective copies of the suitable media player application properly configured (e.g., MythTV for Linux, or WMC for Windows, as mentioned herein above) along with six cable channel tuners operating respective guest OS instances and respective copies of the suitable media player application properly configured (again, MythTV for Linux, or WMC for Windows). A cable channel tuner can be a combination of a Set Top Box (STB) and a converter (as discussed in detail herein below) or any type of custom device which tunes and converts the signal to appropriate recording levels.

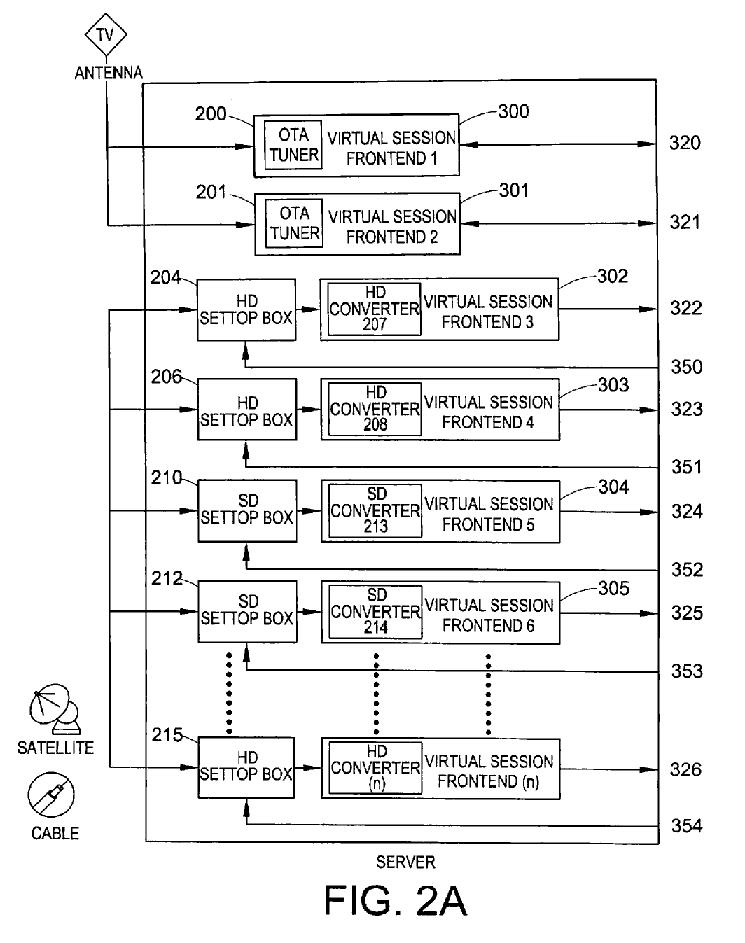

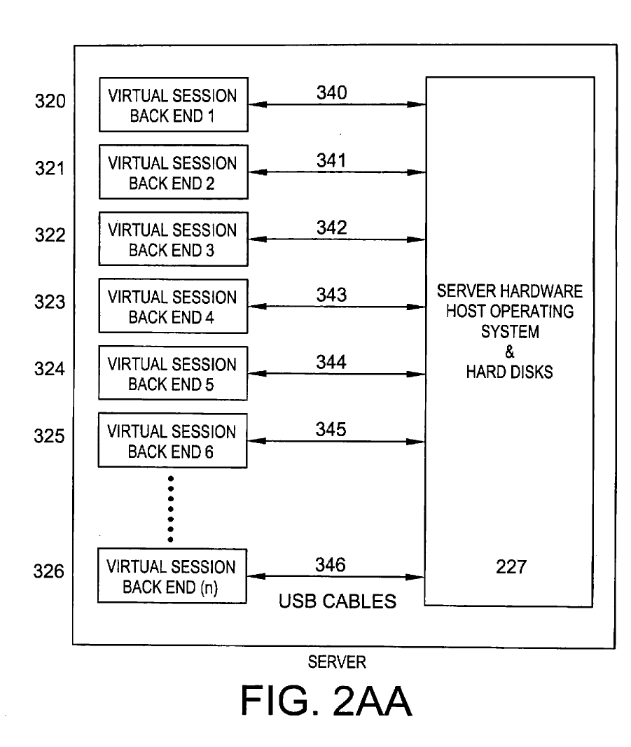

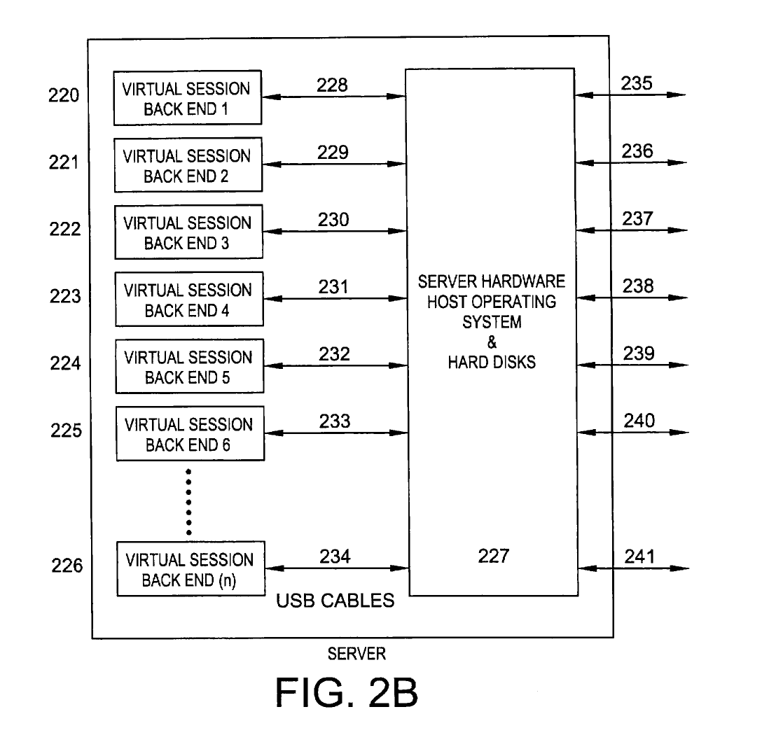

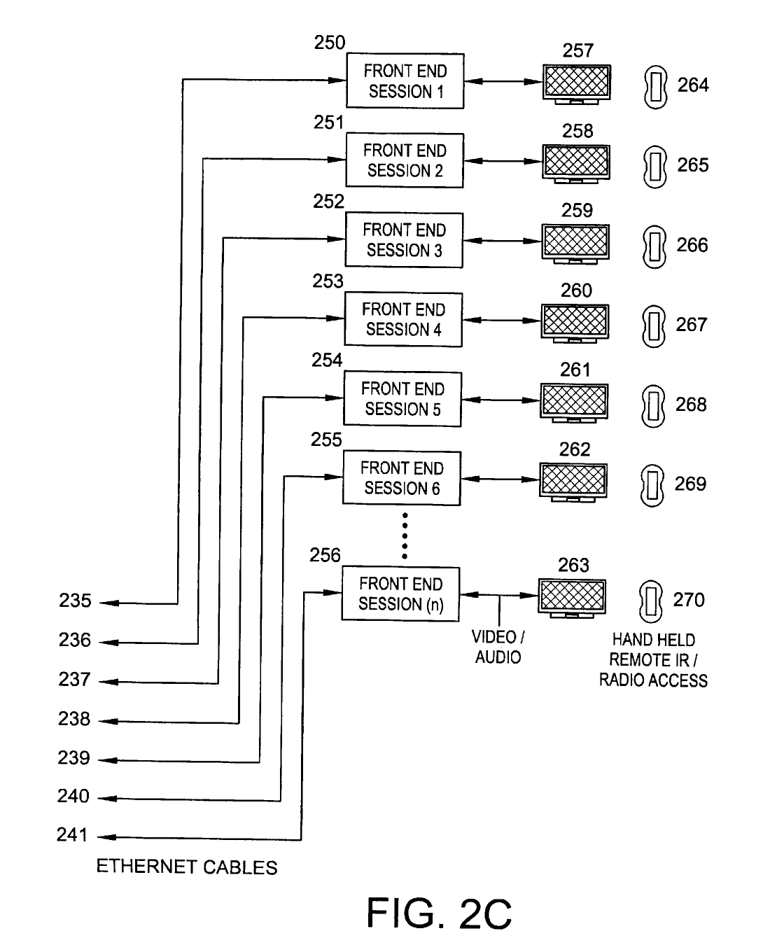

With respect to FIGS. 2A, 2AA, 2B, and 2C, an exemplary system is described herewith. FIGS. 2A and 2AA generally depict components operating in a recording mode to comprise a recording module for feeding received signals into a server-driven recording device. FIGS. 2B and 2C generally depict similar components operating in a playback mode to comprise a playback module, for reading out signals from the server-driven recording device. A server (disclosed in detail herein below) can record one or more signals received from the recording module, and at a later time, replay the recorded signals through the playback module for later viewing. Alternately, the server can pass signals for live viewing from the recording module to the storage system where they are read by the playback module and then sent to a display. Additionally, the server can record one or more signals from the recording module while simultaneously passing other signals directly through to the playback module for live viewing while also recording.

FIG. 2A shows multiple virtual session frontend session components as used in record mode as the recording module. Each frontend component can include either a tuner that can be run under a virtual installed application and virtual operating system, or a converter that is run under the virtual installed application and virtual operating system which is fed from a Set Top Box (STB) that is used to actually tune the selected station. As shown in FIG. 2A, first and second “over-the-air” (OTA) tuners (200), (201) may be duplicate identical devices, for instance, they may be Advanced Television Standards Committee (ATSC) high definition digital television broadcast signal tuners. The OTA tuners (200), (201) are associated with respective instances of the recording module including respective virtual session frontend session components (300), (301). In other embodiments, however, different devices may be used. These devices are complete tuners that are remotely controlled by a virtual instance of a media player application (e.g., MythTV or WMC) running under a respective instance of a virtual session backend component (virtual guest OS) (220-FIG. 2B).

As especially indicated in FIGS. 2A and 2AA, six virtual instances of the recording module are indicated, represented by respective recording virtual session frontend components (300), (301), (302), (303), (304), (305) and are associated with respective recording virtual session backend components (320), (321), (322), (323), (324), (325), where each respective frontend/backend pair represents a respective virtual instance of the recording module. The OTA tuners (200), (201) receive an input signal from an antenna via a coaxial cable and output a signal to a USB port. The channel selection for these tuners (200), (201) may be done by or through the media player application loaded in the respective virtual session frontend component (300).

If the user has established a schedule for recordings by this tuner, it is desirable for the system to directly set the tuner to the correct channel and begin a recording job. A manual, immediate channel change of the OTA tuners (200), (201) (FIG. 2A) may be performed using respective hand held IR remote controls (264), (265) (FIG. 2C) to send a signal to an JR sensor attached to an associated frontend component (250), (251) of a respective playback module, which are client devices. The signal is then passed through a server (227) (FIG. 2B), over a first or second connection (235), (236) to a respective first or second virtual session frontend component (300), (301) (FIG. 2A) to a respective first or second tuner (200), (201). The first and second connections (235), (236) (FIG. 2B)can be associated Ethernet cables (235), (236) that correspond to the respective data paths of USB cables (228), (229) that support movement of the signals along the path between the frontend components (250), (251) (FIG. 2C)and the respective OTA tuners (200), (201) (FIG. 2A).

As shown especially in FIG. 2AA, when functioning in recording mode as the recording module, the backend components (320), (321), (322), (323), (324), (325) function to convert data streams into a suitable format so that the streams can be recorded onto a hard disk or other storage device associated with the server (227). When functioning as the playback module, the backend components (220), (221), (222), (223), (224), (225) (FIG. 2B) function to retrieve a recorded file from the storage device on the server (227), perform the appropriate conversion and deliver the signal to an Ethernet card for sending to the associated frontend, where it passed through to a display controller for Ethernet-to-video signal conversion.

It is to be appreciated that antenna and cable connections coming into a structure (residence or business) can be split to feed multiple tuners and connect with a computer over a short distance (e.g., signal distances of a few feet or meters). Such short distances can be accommodated by USB devices. However, connections from the server (227) (FIG. 2B) to the displays can run dozens or hundreds of feet or meters. For sending signal down such distances, a conversion to an Ethernet signal is used, for transmission over suitable cable, where conversion is made to an audio/video signal usable for display.

As will be appreciated by those skilled in the art, numerous adjustments can be contemplated. The hardware described above, for example, is used for illustrative purposes only, and is not intended to limit the scope of the disclosed aspects. For instance, the remote controls (264), (265) (FIG. 2C) may use different frequencies, other than or including IR. Of course, the corresponding sensor should be configured to cooperate with the remote control such that they are capable of communication over the selected frequencies. Alternately, there can be any number of ATSC tuners, NTSC tuners, or OTA tuners, or any other types of tuners such as can used in this system. The number of tuners operatively connected to or in use with the system is limited only by the number of USB or other appropriate ports on the system. The IR remote can also used by the media player application (e.g., MythTV) to control other functions of the program operation including login/logout and tuner selection.

HD set top boxes (204), (206) (FIG. 2A), according to one embodiment, are ATSC high definition digital television capable set-top boxes (STBs) that are compatible with the signals received from a customer's cable or satellite “broadcast” system. In operation, the received signals may be delivered to these boxes through a coaxial cable from the input to the home or business. The channel selection on these boxes may be controlled by an IR signal relayed through HD converters (207), (208) respectively. In one aspect, the HD converters (207), (208) can be within the virtual session frontend (302), (303), which are fed from the HD

STBs (204), (206) connected to a cable or satellite feed. The output from these STBs may comprise any format, such as in the form of a “composite”, “component”, “DVI”, or “HDMI” television signals which normally are used to drive a television set.

Generally, these signals are not usable by the computer and must go through appropriate HD converters (207), (208) (FIG. 2A), respectively, for converting the HD signals to computer-readable signals. However, the cable or satellite supplied signals may be used by the computer if the computer includes a suitable interface and software capable of performing the conversion capability. In any event, the output of the converter comprises a computer appropriate signal, for instance on a USB cable. The USB cable may be operatively connected to the host computer, either in a wired or wireless manner. The cable can be plugged into a USB port on the host computer and be processed by the application backend running in a virtual session.

The present system can be configured to operate with MythTV, an open source digital video recorder application supported by various operating systems including Linux, BSD, MacOS X, and Windows. MythTV is a media player application for running tuners and STBs, preparing data for storage, and playing back the data on demand on a display (e.g., a television monitor). If a user has established a recording schedule in MythTV for an HD STB, commands will be sent as needed from MythTV (for channel changes) to an IR emitter in the converter. Manual, on demand channel changes may be performed by a user with a hand held IR remote control that may be received by an IR sensor on the playback frontend devices (252), (253) (FIG. 2C)and passed via the cables and the playback backend system (230), (231) (FIG. 2B)to the previously mentioned IR emitter on the converter (207), (208) (FIG. 2A). The IR remote may also use MythTV to control all other functions of the program operation include login/logout and tuner selection.

It is desirable to use the highest possible signal quality. To retain the highest possible quality, any method, connection, or signal processing known to those skilled in the art may be used. For example, 1080i or 1080p lines of resolution, either using the “component” or the “DVI” signal may be used. In some embodiments, there can be any number of “HD converters” on a system, limited only by the number of HD STBs, USB ports on the computer, and the capacity of the system to handle the workload. Each HD converter may be fed by an HD (ATSC) set top box.

SD set top boxes (210), (212) (FIG. 2A) may comprise NTSC (National Television System Committee) standard definition analog STBs which are compatible with the customer's cable or satellite “broadcast” system. The received signal can be delivered to these boxes through a coaxial cable from the input to the home or business, although any other type of connection may be used. The channel selection on these boxes may be controlled by using a variety of methods, including being controlled by an IR signal relayed through first and second Standard Definition (SD) converters (213), (214) respectively. The output from these STBs may have the form of a signal normally used to drive a television set. These signals may comprise broadcast composite, or video, both with stereo audio on adjacent cables. The signals are generally not usable by the computer, and may need to be processed by appropriate converters (213), (214), respectively, if such a function is not included in the computer's capabilities. Accordingly, the output of the converter is a computer appropriate signal on a USB cable. The SD converters (213), (214) can be within the virtual session frontend (304), (305). These sessions are fed from the SD STB (210), (212) which are connected to a cable or satellite feed. It is to be appreciated that there is no limit to the number of OTA, HD and SD connections that can be implemented.

Turning again to FIG. 2AA, a data path is depicted between recording virtual backend sessions (320), (321), (322), (323), (324), (325), (326) and a server (227). The output from the recording virtual backend sessions (320), (321), (322), (323), (324), (325), (326) are connected to respective recording virtual frontend components (as shown in FIG. 2A) which process signals for recording. The connections to the OTA tuners (320), (321) are shown as bi-directional so that if the user instructs a channel change (via a remote control, as indicated below), the signal will come in to the tuner and it will change channels. Connections (350), (351), (352), (353), (354) (FIG. 2A) are respective connections from the recording virtual backend sessions (320), (321), (322), (323), (324), (325), (326) to the respective STBs (204), (206), (210), (212), (215) so that if the user selects a channel change through a respective remote control, the command will go to the respective STB to perform the channel change.

The connections between the set top boxes and their associated converters are dependent on the connections available on each device. These connections can be within inches or a few feet, and of various types as set by their respective manufacturers. The connections between the recording virtual frontend sessions (302), (303), (304), (305) (FIG. 2A) and the respective recording virtual backend sessions (322), (323), (324), (325) can also be defined by the equipment manufacturer. In one aspect, these connections can include cabling and connectors in accordance with USB2 standards or any other suitable type of connection, along with connections within the server (227) (FIG. 2AA). Also, it is to be understood and appreciated that the frontend and backend components can be software or hardware components, or can be components residing within any other discrete software or hardware components.

In one aspect, it is contemplated that the disclosed embodiments could function with MythTV, implemented herein as a client/server component that cooperates with the respective frontend and the backend components, which both have dual functions in the respective recording and playback modules. A copy of both the frontend and backend components is retained in each of the virtual sessions. In each virtual session, the recording frontend components (300), (301), (302), (303), (304), (305) (FIG. 2A) run the respective tuners to receive TV program signals or other input and convert it to a computer-readable form that can be accepted by the recording backend session components (320), (321), (322), (323), (324), (325) which are then further converted to be storable by the virtual OS on a hard disk of the server (227) (FIG. 2AA).

As shown particularly in FIGS. 2B and 2C, a playback mode includes playback frontend session components (250), (251), (252), (253), (254), (255), (256) (FIG. 2C) that are provided to support playback operations. When a user wants to watch a recorded program, a respective frontend component operating with MythTV under a copy of the virtual OS requests the recorded program from the server (227) (FIG. 2B). A respective one of the playback virtual backend session components (220), (221), (222), (223), (224), (225), (226) operating with MythTV pulls the recorded program from the hard disk on the server (227). The respective frontend component receives the recorded program through a respective Ethernet cable (235), (236), (237), (238), (239), (240), (241) to an associated sub-micro PC that converts the Ethernet class signal to a composite, component, or HDMI signal (with accompanying audio) and feeds the converted television signal to the respective one of the display monitors (257), (258), (259), (260), (261), (262), (263) (FIG. 2C).

If a user has established a recording schedule in MythTV, commands may be sent as needed from MythTV for channel changes to an IR emitter in the respective SD converter (214), (213) (FIG. 2A). These signals may be detected by the IR sensor in the STB, and the channel change may be implemented. Manual, on demand channel changes may be performed by a user with a respective hand held IR remote control (267), (268) (FIG. 2C) that are received by an IR sensor on a respective frontend device (254), (255) and passed via the respective Ethernet cables (239), (240) and USB cables (239), (240) and backend system (232), (233) (FIG. 2B) to the previously mentioned IR emitter on the respective SD converter (214), (213) (FIG. 2A). The IR remote may also be used by the MythTV to control all other functions of the program operation including login/logout and tuner selection.

A single system may include various elements. In one embodiment, as shown in FIG. 2B, a playback system may comprise a playback virtual backend system (220) running on a host server (227), a USB connecting cable (228) from the tuner or converter to the backend (220) (on the server), and a physical USB Port 1, logically on the virtual server, in the host (not numbered). Also included is a virtual copy of the OS along with a virtual copy of the application backend (220) on the server (227), an Ethernet cable to frontend session on mini-pc (235), and a frontend processor (250) (FIG. 2C), a display (e.g., monitor) (257), and an IR sensor and remote control (264).

A user will frequently schedule recordings of shows ahead of time, and a built in timer function will set the tuner to the correct channel and activate operation at the correct time to receive the program on that tuner. The playback operation is typically “on demand.” In a common implementation, the user is sitting in front of the monitor upon which they want to watch the playback. The user can use an IR or radio wave remote to command the frontend to playback a recorded program (picked from a list of recordings available). The frontend then immediately directs the backend to retrieve the selected recording. The tuner component(s) are not used during play back.

As described herein, the individual frontend session components (250), (251), (252), (253), (254), (255), (256) (FIG. 2C) may be distinct hardware components that each include a custom processor system, a host OS running therein, and an application (e.g., MythTV) operating on each frontend. During playback mode, a program to be watched may be selected using a respective monitor (257) operatively connected to a frontend session (250) to operatively connect to a respective virtual backend (220) (FIG. 2B), where a list of available programs may be viewed. Although it may be implemented in a variety of manners, a hand held standard version remote control (264) (FIG. 2C) may be manipulated by a user to make selections. The signal from the remote (264) is desirably received by an appropriate detector attached to the monitor (257). The data file (e.g., the video program) is read from a hard disk on the host server (227) (FIG. 2B) by the virtual backend (220) and sent to the Ethernet port (235) for delivery to the respective frontend (250) (FIG. 2C).

The host operating system may provide access time to each of the respective virtual backends (220), (221), (222), (223), (224), (225), (226) (FIG. 2B) and mediate traffic to each of the respective Ethernet ports. The hard disk can be used to record video program data files received from any of the backend components of the host server (227). The operative connection between the host server (227) and each of the frontend units is similar to that of a client/server wherein the host server (227) does nothing other than feed data with substantially all of the processing being done by the individual frontend and backend systems.

The data path from the server (227) (FIG. 2B) to frontend session 1 (250) (FIG. 2C) and for each additional frontend session system 2-n (250), (251), (252), (253), (254), (255), (256) may be over the respective Ethernet cables (235), (236), (237), (238), (239), (240), (241). The data path from frontend session 1 (250) to the respective first monitor (257) and likewise between all other respective frontends and monitors, such as from frontend session n (256) to respective monitor n (263), may comprise a video/audio cable such as HDMI or a video cable and audio cables such as DVI video and appropriate audio cables. The respective frontend components perform conversion from Ethernet to a standard TV signal to prepare the signal for presentation on a standard TV (SD or HD). The overall system may be controlled manually, for example using a hand held remote (264) that generates an appropriate IR or radio signal.

As described herein, each of the virtual session backends (220), (221), (222), (223), (224), (225), (226) (FIG. 2B) can comprise a virtual complete system created by running KVM (kernel-based virtual machine) virtualization software on a host package comprising an instance of an operating system which can be Red Hat Fedora X86_{—}64, a fully supported product. Other virtualization software may optionally be used. The presence of the KVM frontend allows the KVM backend to load and supports the loading of additional individual copies of Red Hat Fedora to create multiple virtual systems. KVM is used as it is fully supported by Fedora and any bugs that are discovered may be evaluated and corrected as rapidly as possible in keeping with other problems found. Additionally bug fixes will not be introduced that cause other problems on the system.

Each of the respective virtual backend components (220), (221), (222), (223), (224), (225), (226) (FIG. 2B) can implement MythTV, and may be loaded on each copy of Fedora. Each of the respective frontend session components may comprise a copy of Fedora loaded natively on the computer hardware. This OS software performs the Ethernet to video/audio system format conversion in concert with the support provided by the front portion of MythTV which is loaded on the OS. It is important to note that the present implementations are not limited to Fedora Linux or the use of KVM as a virtualization agent. For example, the present system may be implemented using SuSE Linux from version 10 forward and with VMWare Workstation from version 6 forward. The software on the frontend session components (250), (251), (252), (253), (254), (255), (256) (FIG. 2C) is also not limited to Fedora Linux.

Accordingly, any software or system known to those skilled in the art may alternatively be used.

In another aspect of the disclosed system, there may be instances where no tuner is needed to process the signal. For example, a raw signal from cameras may be recordable directly by the computer with its software. Signals from multiple cameras can be fed through multiple ports with each port in its own virtual environment. This can provide functionality as with security systems or other monitoring systems for residential, commercial, civilian government, or military/intelligence applications.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed:

1. A virtualization system, comprising:
a plurality of signal source components for supplying audio and/or visual signals;
a plurality of recording modules for receiving and implementing the audio/visual signals as computer-readable data signals;
a host server for receiving the data signals from the recording modules recording the data signals to a storage component;
at least one playback module for retrieving the data signals from the storage component and for implementing the data signals as audio/visual signals to be displayed on a display component; and
a selection component for selecting one of the audio/visual signals from the storage component for presentation on the display component.

2. The virtualization system of claim 1, wherein the at least one signal source component comprises at least one tuner for receiving television signals, and a signal converter for converting the television signals into the data signals.

3. The virtualization system of claim 2, wherein the at least one tuner comprises at least one of:
an “over-the-air” tuner for receiving television signals from an antenna;
a high definition ATSC set top box for receiving television signals from one of a satellite or a cable; or
a standard definition NTSC set top box for receiving television signals from one of a satellite or a cable.

4. The virtualization system of claim 1, wherein the at least one signal source component comprises a plurality of cameras in a monitoring system.

5. The virtualization system of claim 1, wherein the recording modules comprise a plurality of virtual session backend components for exchanging data signals with the host server, each comprising an instance of an operating system for running a respective signal conversion application.

6. The virtualization system of claim 5, wherein at least one of the virtual session backend components comprises an instance of an operating system different from the instances on the respective other virtual session backend components.

7. The virtualization system of claim 1, wherein the recording modules each comprise a virtual session frontend component including a respective signal source, and a signal converter for converting the audio and/or visual signals into the data signals.

8. The virtualization system of claim 1, wherein the playback module comprises at least one virtual session backend component comprising an instance of an operating system for running a respective signal conversion application.

9. A television virtualization system, comprising:
a plurality of recording modules each comprising a recording virtual session frontend component including at least one signal source component for supplying television signals as computer-readable signals, and a respective plurality of recording virtual session backend components for receiving and implementing the computer-readable signals as data signals;
a host server for receiving the data signals from the plurality of virtual session backend components and serving at least one of the data signals;
a storage component of the host server for optionally storing at least one of the data signals in a respective data file corresponding to a video program; and
at least one playback module comprising a playback virtual session backend component for receiving the at least one of the data signals served from the host server and for implementing the data signals as television signals to be displayed on a television monitor component.

10. The television virtualization system of claim 9, wherein the storage component comprises at least one hard disk for recording the video program.

11. The television virtualization system of claim 9, further comprising a selection component for selecting one of the television signals from the plurality of virtual session backend components for presentation on the television monitor component.

12. The television virtualization system of claim 11, wherein the selection component comprises a remote control for selecting one of the television signals for live presentation or playback from the storage component on the television monitor component.

13. The television virtualization system of claim 11, wherein the selection component comprises a recording schedule established in the signal source component for recording a video program on the storage component.

14. The television virtualization system of claim 9, further comprising a plurality of USB connections for establishing respective data paths between the plurality of virtual session backend components and the host server.

15. The television virtualization system of claim 9, further comprising a plurality of Ethernet connections for establishing respective data paths between the host server and the playback module, and connected to a respective plurality of television monitor components.

16. The television virtualization system of claim 9, wherein the at least one signal source component comprises a tuner selected from at least one of:
an “over-the-air” tuner for receiving television signals from an antenna;
a high definition ATSC set top box for receiving television signals from one of a satellite or a cable; or
a standard definition NTSC set top box for receiving television signals from one of a satellite or a cable.

17. The television virtualization system of claim 16, further comprising a signal converter for converting the television signals from the tuner into the computer-readable signals.

18. The television virtualization system of claim 9, wherein the respective virtual session backend components, the host server, and the frontend session component each comprise a virtual copy of an operating system for running a media player application.

19. A method of television virtualization, comprising:
receiving multiple television signals corresponding to multiple video programs from a plurality of tuners;
converting the multiple television signals into multiple computer data signals;
storing a plurality of the computer data signals in respective stored data files corresponding to respective video programs on a storage component; and
implementing at least one of the respective stored data files as television signals to be displayed on a television monitor component.

20. The method of claim 19, further comprising updating program listings corresponding to the multiple video programs according to a schedule.

21. A virtualization system, comprising:
a plurality of signal source components for supplying signals from a component HVAC or utilities system;
a plurality of input modules for receiving and converting the source signals to computer-readable data signals;
a host server for receiving the data signals from the input modules and recording the data signals to a storage component;
at least one output module for retrieving the data signals from the storage component and for implementing the data signals; and
a selection component for selecting one of the signals from the storage component.
